(19) United States
(12) Patent Application Publication
(10) Pub. No.: US 2017/0331086 A1
(43) Pub. Date: Nov. 16, 2017

(54) BATTERY HOLDER FOR A VEHICLE

(71) Applicant: Benteler Automobiltechnik GmbH, Paderborn (DE)

(72) Inventors: Andreas FREHN, Delbrueck (DE); Georg FROST, Steinheim (DE); Christian HANDING, Langenberg (DE)

(21) Appl. No.: 15/592,531

(22) Filed: May 11, 2017

(30) Foreign Application Priority Data
May 12, 2016 (DE) 10 2016 108 849.8

(51) Int. Cl. H01M 2/10; C22C 38/00; C22C 38/34; C22C 38/26; B60K 1/04; C22C 38/04; C22C 38/02; C22C 38/06; C22C 38/28

(52) U.S. Cl. CPC H01M 2/1083; C22C 38/06; C22C 38/002; H01M 2/1094; C22C 38/34; C22C 38/28; C22C 38/26; B60K 1/04; C22C 38/04; C22C 38/02; B60K 2001/0438; H01M 2220/20

(57) ABSTRACT

A battery holder is disclosed having a base plate and a frame that is at least partially encircling in a lateral direction, the base plate and the frame are configured as sheet-metal components, and a lid. The base plate is configured in a trough-shaped manner and is manufactured as a formed sheet-metal component from a multilayered laminated composite steel, wherein an internal exterior layer is configured from an acid-resistant steel alloy and an outboard external layer of the laminated composite steel is configured from a stainless-steel alloy.

### CROSS REFERENCE TO RELATED APPLICATIONS

The present application claims priority from German Application Number 10 2016 108 849.8, filed May 12, 2016, the disclosure of which is hereby incorporated by reference herein in its entirety.

### BACKGROUND OF THE INVENTION

### 1. Field of the Invention

The present invention relates to a battery holder, and more specifically, to a battery holder for a motor vehicle.

### 2. Description of the Related Art

Internal combustion engines are mostly used in automobiles nowadays. The internal combustion engines, by way of the combustion procedure, convert the chemical energy contained in the fuel to mechanical propulsion energy.

However, there has been a rise in a number of hybrid vehicles and electric vehicles in the market more recently. In the case of a hybrid vehicle, an electric motor is combined with an internal combustion engine. The electric motor and the internal combustion engine work, for example, in series or else in parallel. In the case of an electric vehicle, only an electric motor is utilized.

The electric energy has to be stored in the automobile. Batteries, also referred to as accumulators, are accommodated in the automobile. In order for correspondingly large operating ranges of up to several hundred kilometers to be implemented, batteries or accumulators, respectively, have to be provided with a storage capacity that is commensurate therewith. Such batteries have geometric dimensions in the case of a volume of in some instances more than 100 liters, and a dead weight of in some instances more than 100 kg.

The batteries are accommodated in an underfloor region, a rear region, or a front-end region in the automobile. In order for a center of gravity of the automobile that is as low as possible to be implemented, the batteries in relation to the road holding of the automobile are disposed as close as possible to the ground, therefore, in the floor region or the underfloor region.

Battery holders, which are also referred to as battery trays, are known from the prior art. Such battery trays are known from EP 2 501 576 A1, for example. The battery trays can be permanently coupled so as to be integrated into the automobile body, in particular into the structure of the automobile body. It is also possible for battery trays to be coupled to an automobile as replaceable units.

As the smallest constructive unit, battery holders are also known for receiving the starter battery of an automobile, wherein the automobile is primarily driven by an internal combustion engine.

### SUMMARY OF THE INVENTION

It is an object of the present invention to provide a battery holder which can be manufactured in a simple manner, complies with all regulatory and manufacturer-issued requirements for receiving a battery, has a long life span, and optionally improves the crash behavior of an automobile.

The battery holder for an automobile has a base plate and a frame that is laterally at least partially encircling. In particular, the base plate is configured as a formed sheet-metal component. The battery holder furthermore has an optional lid. According to the invention, the battery holder is distinguished in that the base plate is configured in a trough-shaped manner and is manufactured as a formed sheet-metal component from a multilayered laminated composite steel, wherein an outboard external exterior layer of the laminated composite steel is configured from a stainless-steel alloy.

The multilayered laminated composite steel herein is configured from at least two layers. Said multilayered laminated composite steel has a main layer, or a central layer, respectively, which is smaller than 90% of the total thickness. In particular, this layer is configured from a hot-formed and press-hardened heat-treatment steel. For example, a manganese-boron steel is employed. An exterior layer can further be configured. The exterior layer in terms of the installed situation of the battery holder is oriented away from the automobile, pointing toward a carriageway surface. The exterior layer is also referred to as the external exterior layer. According to the invention, the exterior layer is configured from a stainless-steel alloy, in particular from a ferritic stainless high-grade steel alloy.

The use of an alloy which apart from the impurities caused by ore-melting and from iron comprises the following alloy components in percent by weight has proven particularly advantageous as a ferritic non-corroding or stainless high-grade steel alloy, respectively:

Carbon (C): 0.08% to 0.16%

Silicon (Si): 0.5% to 1.8%

Manganese (Mn): 0.8% to 1.4%

Chromium (Cr): 13.0% to 22.0%

Aluminum (Al): 0.5% to 1.5%

Phosphorous (P): maximum 0.06%

Sulfur (S): maximum 0.02%.

In terms of further ferritic non-corroding steel alloys which can be used reference is hereby to be made to the content of EN 10088-1, having chromium contents between 10.5 and 30%, depending on the grade. Stabilizing additives of less than 0.5% of titanium, niobium, or zirconium, and the carbon content that is limited to 0.16% serve for guaranteeing the capability of welding.

A triple-layer laminated composite steel is preferably used. This triple-layer laminated composite steel has two exterior layers and one central layer, or a middle layer that is disposed between the exterior layers.

The inboard layer in terms of the installed situation of the battery holder is referred to as the internal exterior layer. In terms of a passenger cabin of the automobile, this internal exterior layer is directed inward. The outboard exterior layer in terms of the automobile is directed toward the outside. The outboard exterior layer is therefore referred to as the external exterior layer. The central layer, also referred to as the middle layer, is enclosed by the two exterior layers.

The battery holder is configured as a constructive component or as a welded component, or as a physically integral and materially integral component which is then closed by a lid. The battery holder is configured so as to be box-shaped or trough-shaped, and can thus receive the batteries or accumulators in an interior space thereof. The battery holder can consequently also be referred to as the battery tray, battery box, or battery receptacle.

One of the advantages of the battery holder is that the central layer is configured from a steel material, in particular from a hardenable steel material. Thus, the requirements pertaining to the crash behavior and the rigidity behavior can be complied with, specifically in the case of an integration of the battery holder into the automobile body. Resistance to corrosion is provided by an internal exterior layer from a stainless steel alloy.

Furthermore, the internal exterior layer can also be configured from a steel alloy that is simultaneously acid-resistant. Thus, manufacturer-issued requirements as well as regulatory requirements can be complied with according to which the batteries that are partially filled with battery acid in the case of an unexpected leakage of battery acid, initiated by material failure, for example, or else by a crash, is trapped and thus does not leak into the environment.

Weather-related influences such as moisture, as well as other influences such as road salt, in the underfloor region of an automobile can be resisted by the outboard exterior layer from a stainless-steel alloy. Corrosion that arises by use of a vehicle over years or decades and that would lead to perforation corrosion can thus be counteracted. At the same time, a corresponding stainless-steel alloy as the outboard layer offers the advantage that a protection from road stone impact is provided.

The exterior layers are coupled to the central layer in particular in a materially integral manner The laminated composite steel is manufactured by rolling, in particular. It is an essential inventive advantage that a central layer from heat-treatment steel, having two exterior layers from a ferritic stainless steel is particularly positively hot-formable and press-hardenable. In the case of the aforementioned combination of materials no significantly dissimilar warping due to thermal causes arises during hot-forming and press-hardening, such that the component is readily formable from the blank. Furthermore, a manufactured component having high dimensional accuracy can be achieved. Rebound effects or internal stress states are almost avoided by way of the combination of materials.

The battery holder is configured in particular as a propulsion battery of a hybrid vehicle or of an electric vehicle. To this end, battery types of various respective sizes are known. However, a plurality of batteries can also be switched in series or in parallel in order for a respective battery to be configured.

The battery holder is also employable as a battery holder for a starter battery. One of the advantages is that an acid-resistance of the internal layer is provided. The battery holders for a starter battery are most often accommodated in the engine bay of an automobile body.

In a preferred embodiment, the base plate is already configured so as to be trough-shaped. A leaking liquid, in particular battery acid, can thus be trapped in the trough. An at least partially encircling frame can be manufactured from a material that is different from the triple-layer laminated composite material of the base plate. In this instance, the frame and the base plate can be intercoupled, for example by adhesive bonding and/or welding. The coupling is performed in particular in a fluid-tight manner. However, it is also possible for the frame and the base plate to be configured from the same material. The frame and the base plate in this instance are configured as separately manufactured components which are subsequently intercoupled. The coupling can be performed by adhesive bonding and/or welding.

In another embodiment, the base plate is configured so as to be physically integral and materially integral to the frame. A deep-drawing method lends itself particularly to this end. The base plate is configured so as to be trough-shaped. In this instance, a base plate that is physically integral and materially integral to the frame is configured so as to be trough-shaped, in particular as a deep trough. The latter are particularly suitable for integrating the battery holder as a structural component into the automobile body. The battery holder is disposed between door sills or else between wheel arches of an automobile body, and in particular is coupled in a materially integral manner, preferably welded to the aforementioned components.

At least the base plate and optionally the frame are hardened. The central layer is configured from a hardenable steel alloy, for example from a boron-manganese steel of the type 22MnB5. However, boron-manganese steel types with a high carbon content, for example a steel of the type 38MnB5, are also usable.

The aforementioned steels can be manufactured in particular by hot-stamping and press-hardening, so as to have desired high-tensile or even ultra-high-tensile material properties. A direct hot-stamping process can be carried out to this end, for example. A triple-layer laminated composite steel blank is heated beyond the austenitizing temperature, is formed in this hot state, and is press-hardened by rapid cooling in the forming tool. However, an indirect hot-forming process can also be carried out. The triple-layer laminated composite steel blank herein is initially formed in the cold state, is subsequently heated to beyond the austenitizing temperature, and is correspondingly hardened by rapid cooling.

Preferably, a tensile strength Rm of the central layer of greater than 1300 MPa, in particular greater than 1700 MPa, and preferably greater than 1800 MPa, and particularly preferably greater than 1900 MPa is set. A steel of the type 38MnB5 is used, for example.

In order for the crash performance to be further improved, corrugations are preferably molded into the base plate and/or the lid. The corrugations in the installed position of the battery holder can run so as to be oriented in the transverse direction of the automobile. On account thereof, the lateral rigidity is increased in the event of a lateral impact. However, the corrugations can also run in the longitudinal direction of the automobile.

Furthermore, the lid lies on or bears on a frame in the region of the upper side thereof. Preferably, the frame and the lid are intercoupled in a fluid-tight manner and, moreover, preferably also in a gas-tight manner. The coupling is performed in particular by seal welding and/or adhesive bonding. After insertion of the batteries into the battery holder and closing it with a lid, the batteries are tightly received in the battery holder. The lid or the frame can have respective openings for routing connector lines, so as to conduct the electric energy from the batteries that are located in the battery holder to, for example, an electric motor. The lid can also be closed by a form-fit and a force-fit. A sealing agent or an adhesive can optionally be disposed therebetween.

The triple-layer laminated composite steel on the exterior is furthermore configured in such a manner that the two exterior layers, thus the internal exterior layer and the external exterior layer, account for part of the total thickness. The central layer in this instance accounts for the remaining part of the total thickness. The thickness of the central layer herein preferably corresponds to 50% to 95% of the total thickness of the triple-layer laminated composite steel. Thus, the two exterior layers together have a thickness which corresponds to 5% to 50% of the total thickness.

Moreover, the thickness of the exterior layers may have an asymmetrical apportioning. In particular, the internal exterior layer in relation to the external exterior layer is configured so as to be thinner. The internal exterior layer is assigned not only to protect against corrosion but also to protect against acid, while the external exterior layer can protect against corrosion. However, in the case of the arrangement in the underfloor region of the automobile, it may be impacted by stone or road debris. In order to protected against an impacting stone for it not to penetrate the external exterior layer and thus to potentially cause corrosion on the central layer, the external exterior layer is configured so as to be correspondingly thicker in relation to the internal layer. For example, the external exterior layer can correspond to 2% to 30%, and more specifically to 5% to 25%, of the total thickness. The thickness of the internal exterior layer in this instance corresponds to 1% to 20%, in particular 2% to 15%, of the total thickness of the triple-layer laminated composite steel.

Moreover, in the case of a component that is manufactured from a double-layer laminated composite steel, or else of a triple-layer manufactured component from laminated composite steel, a metallic coating, for example an aluminum-silicon coating, or a coating that is composed of a zinc alloy, can be applied to the external surface. This coating in particular has a layer thickness of 10 μm to 30 μm. As opposed to the exterior layers from a stainless steel alloy, the coating is applied only to the strip-shaped rolled steel sheet material, in particular by dipping. By contrast, the exterior layer from ferritic stainless steel is preferably applied to the billet or the block, respectively, prior to being rolled to a strip shape.

### BRIEF DESCRIPTION OF THE DRAWINGS

The present invention will now be described, by way of example, with reference to the accompanying drawings, in which:

FIG. 1a is a side sectional view of the battery holder;

FIG. 1b is an enlarged sectional view of the base plate of the battery holder;

FIG. 1c is a top view of the battery holder;

FIG. 1d is an enlarged sectional view of an alternative embodiment of the base plate of the battery holder;

FIG. 2a is a side sectional view of the battery holder in accordance with an alternative embodiment;

FIG. 2b is an enlarged sectional view of the base plate of the battery holder shown in FIG. 2a;

FIG. 2c is the top view of the battery holder shown in FIG. 2a;

FIG. 3a is a side sectional view of the battery holder in accordance with an alternative embodiment;

FIG. 3b is the enlarged sectional view of the base plate of the battery holder shown in FIG. 3a; and,

FIG. 3c is the top view of the battery holder shown in FIG. 3a.

In the figures, the same reference designations are used for identical or similar components, even if a repeated description is omitted for reasons of simplicity.

### DETAILED DESCRIPTION OF SOME EMBODIMENTS

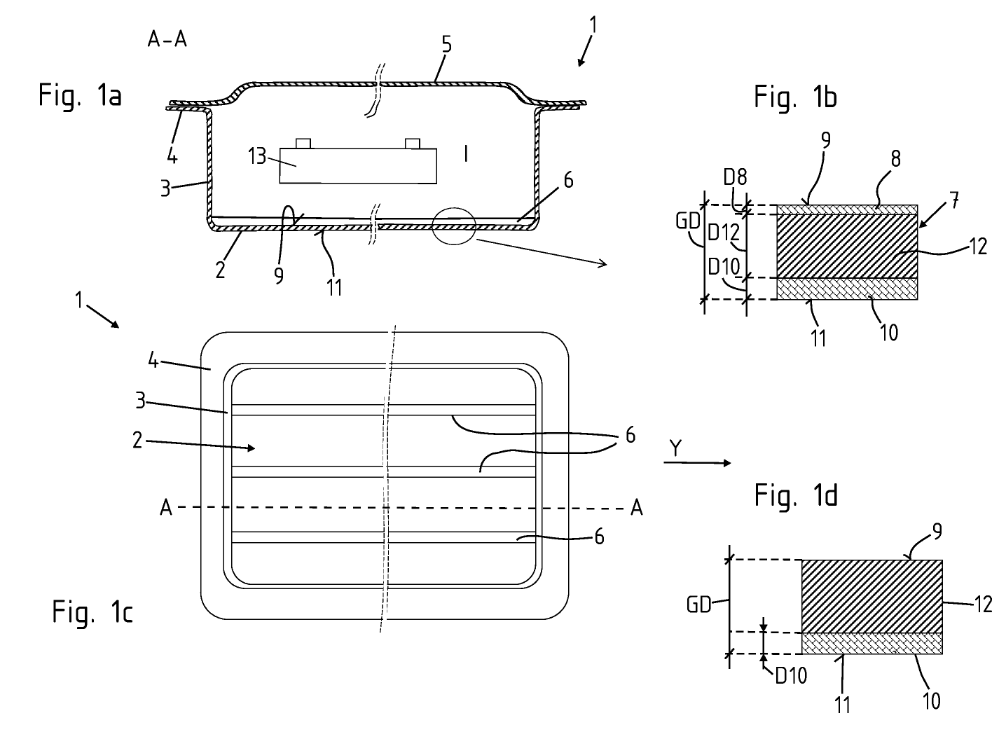

FIGS. 1a and 1c show a side view and a top view, respectively, of a battery holder 1 in accordance with one embodiment of the invention. A base plate 2 that is manufactured so as to be physically integral and materially integral to the externally encircling frame 3 is shown. The base plate 2 and the frame 3 are manufactured as a deep-drawn component, which can be readily seen in the sectional view of FIG. 1a. The base plate 2 together with the frame 3 is configured so as to be trough-shaped, having an externally encircling flange 4. A lid 5 is positioned on the flange 4. The lid 5 and the flange 4 are preferably tightly intercoupled. Tight coupling can be performed by adhesive bonding or welding, or any other suitable means. However, an annular seal is preferably used. A form-fitting coupling in this instance is performed by means of screw bolts. Furthermore, as seen in FIG. 1c, corrugations 6 preferably run in the transverse direction Y to the automobile. This increases the rigidity in the event of a side impact.

FIG. 1b illustrates the base plate 2 having the frame 3 is manufactured from a triple-layer laminated composite steel 7. An internal exterior layer 8 in terms of the installed situation is disposed so as to be oriented toward an internal side 9. An external exterior layer 10 is disposed on an external side 11. A central layer 12 is enclosed by the internal exterior layer 8 and external layer 11. The internal layer 8 and the external exterior layer 10 are thus exterior layers.

The laminated composite steel 7 has a total thickness GD which is made up of the thickness D8 of the internal exterior layer 8, the thickness D12 of the central layer 12, and the thickness D10 of the external exterior layer 10. The proportion of the thickness D12 of the central layer 12 herein is preferably between 50% and 95% of the total thickness GD. Furthermore, the external exterior layer 10 in relation to the internal exterior layer 8 is configured so as to be thicker, preferably more than 1.5 times, in particular more than 2 times, the thickness of the internal exterior layer 8. Therefore, a better protection against the impact by road debris is provided. The internal exterior layer 8 is configured so as to be acid-resistant, such that a schematically illustrated battery 13 that is disposed in the interior (I) is safely received. If the battery acid unexpectedly leaks, the leaking battery acid would correspondingly remain stored in the interior (I). The size of the battery is indicated in a schematic manner only. In particular, the battery may almost entirely fills the interior (I).

FIG. 1d illustrates an alternative embodiment of the double-layer laminated composite steel 7. A main layer, also referred to as the central layer 12, which is smaller than or equal to 90% of the total thickness GD, is now disposed. Furthermore, an external exterior layer 10 in terms of the installed situation is disposed. The external exterior layer 10 thus serves as protection against corrosion and protection against road stone impact.

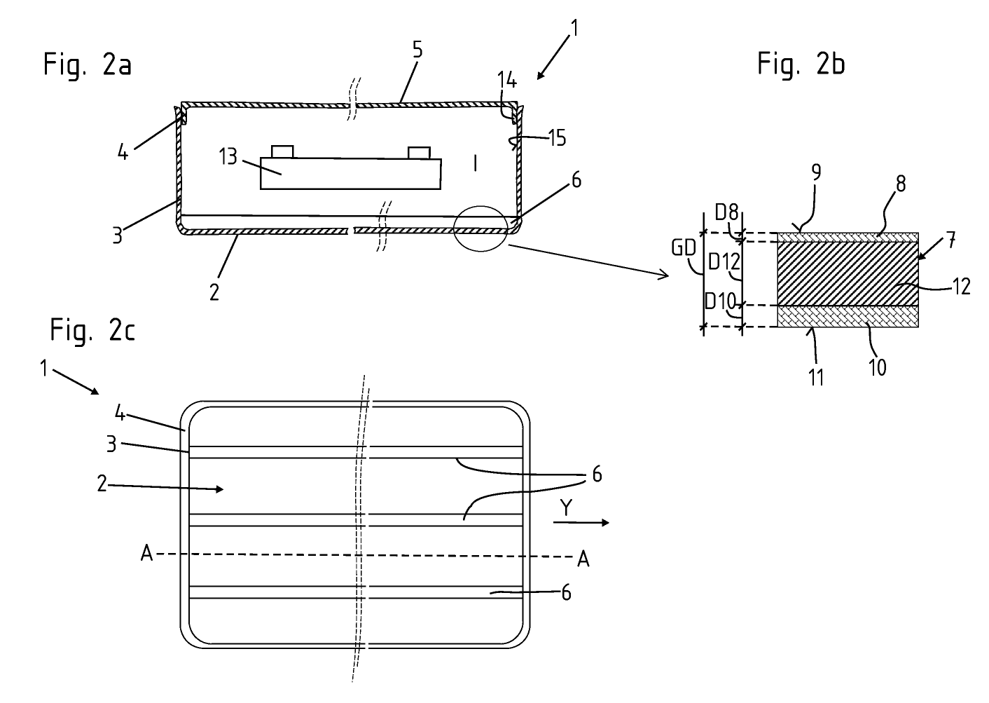

FIGS. 2a to 2c an alternative embodiment of the battery holder of FIG. 1. The frame 3 is preferably also manufactured so as to be physically integral and materially integral as a forming component to the base plate 2. However, this embodiment does not have any outboard flanges. Rather, the lid 5 is placed on top in the manner of a hood. The lid 5 is positioned so that its peripheral ends contact the inside of the frame 3. In the manner of a hood can however also be configured in such a manner that the lid 5 engages across the outside of the frame 3. The lid 5 here has a bent edge 14. The bent edge 14 comes to bear on an internal side 15 of the frame 3, and here in particular is tightly coupled to the latter.

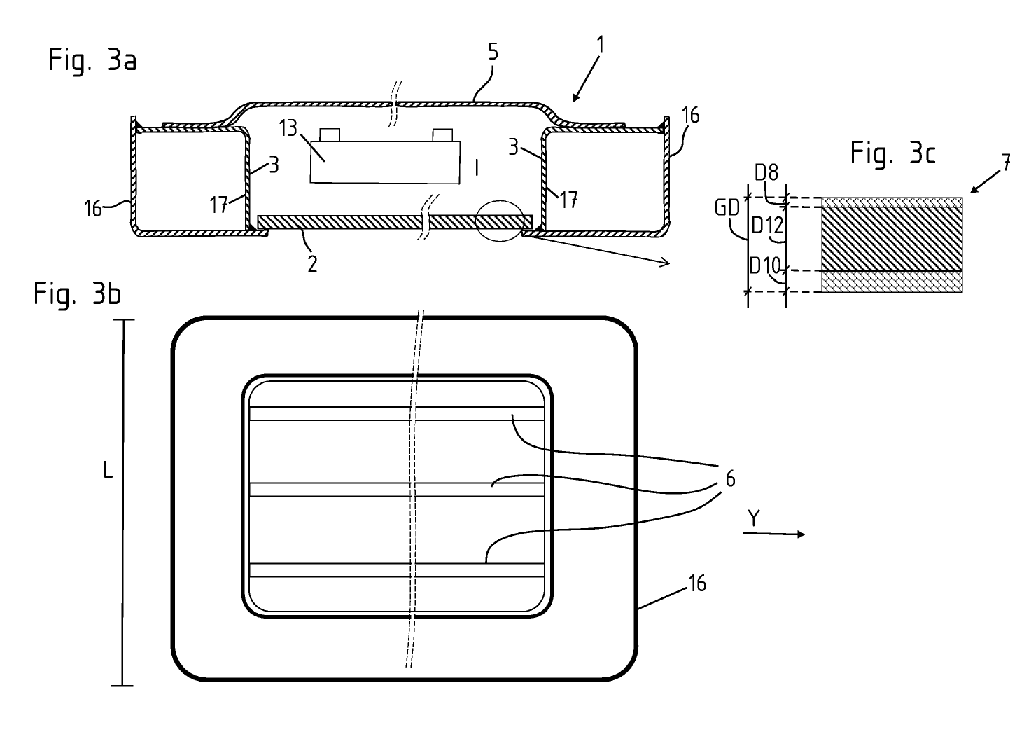

FIGS. 3a to 3c illustrate yet another embodiment of the battery holder shown in FIG. 1. As seen in the sectional view of FIG. 3a, the battery holder 1 has a base plate 2. The base plate 2 is laterally coupled to door sills 16. The door sills 16 are also manufactured as formed sheet-metal components. The door sills 16 have an internal sill part 17. The internal sill part 17 at the same time is configured as the frame 3, and thus at the same time forms the frame 3 for receiving a battery 13. A lid 5 is again placed on top of the door sill 16, such that an interior (I) is provided. The base plate 2 again also has corrugations 6 in order to increase the transverse rigidity. The base plate 2 is configured from the triple-layer laminated composite steel 7, in a manner similar to the embodiments shown in FIGS. 1 and 2 and disclosed hereinabove.

It is also possible for the frame 3 to be formed by a dual-shell deformation element instead of door sills. The external sill part 16 herein is connected to the actual door sill. The deformation element in this case extends at most across the entire length (L) of the battery holder 1. The internal sill part 17 also conforms and configures to the frame 3. In the event of a lateral impact, the door sill is flexurally stressed and is deformed under the energy absorption of the deformation element in such a manner that the external sill part 16 and the internal sill part 17 are deformed and converged.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. A battery holder for a vehicle, comprising:
a frame;
a base plate;
a lid;
wherein the base plate is a trough-shaped sheet-metal component having a multilayered laminated composite steel, and
wherein an outboard exterior layer of the laminated composite steel is a stainless-steel alloy.

2. The battery holder of claim 1, wherein the base plate and/or the frame are configured from a triple-layer laminated composite steel having an internal exterior layer, a central layer, and an external exterior layer.

3. The battery holder of claim 1, wherein the battery holder is configured and dimensioned to hold a starter battery.

4. The battery holder of claim 1, wherein the batter holder is configured and dimensioned to hold a battery for a hybrid vehicle or an electric vehicle.

5. The battery holder of claim 1, wherein the base plate and the frame are intercoupled to one another and are of different materials.

6. The battery holder of claim 1, wherein the base plate and the frame are of the same material.

7. The battery holder of claim 2, wherein the base plate and the frame are integrally formed as a single component.

8. The battery holder of claim 1, wherein the battery holder is integrated into an automobile body.

9. The battery holder of claim 2, wherein the base plate and the frame are hardened, wherein a central layer is configured from a hardened steel alloy, and wherein the battery holder is hot-stamped and press-hardened.

10. The battery holder of claim 9, wherein the tensile strength Rm of the base plate and the frame is greater than 1300 Mpa.

11. The battery holder of claim 9, wherein the tensile strength Rm of the base plate and the frame is greater than 1700 MPa.

12. The battery holder of claim 1, wherein the frame and the lid are tightly intercoupled by way of a force-fit and a sealing agent.

13. The battery holder of claim 2, wherein the internal layer and the external exterior layer each in relative terms are thinner than the central layer, and wherein the central layer has a thickness which corresponds to 50% to 95% of the total thickness (GD).

14. The battery holder of claim 2, wherein the internal exterior layer in relation to the external exterior layer is configured so as to be thinner.
